(19) United States
(12) Patent Application Publication
(10) Pub. No.: US 2010/0044531 A1
(43) Pub. Date: Feb. 25, 2010

(54) Big game poser and method of operation thereof

(76) Inventor: Anthony Sande, JR., Wading River, NY (US)

Correspondence Address: Thomas McNally, P.O. Box 20188, Huntington Station, NY, 11746, US

(21) Appl. No.: 12/229,405

(22) Filed: Aug. 22, 2008

(51) Int. Cl. F16M 11/00

(52) U.S. Cl. 248/157

(57) ABSTRACT

An apparatus and method for positioning an extremity of an animal. The system, apparatus, and method including a base part having a cavity and an adjusting mechanism, one or more legs attached to the base part, an extension member structured and arranged so as to fit within the cavity of the base part and engage the adjusting mechanism, an upper part attached to the extension member, the upper part having bifurcated ends and a center section for holding the extremity of the animal in a desired position.

### FIELD OF THE SYSTEM

The present system relates generally to game trophy mounting devices and, more particularly, to a portable mount for positioning an extremity of an animal, and a method of operation thereof.

### BACKGROUND OF THE SYSTEM

Game animal hunting is a popular sport and is practiced by many hunters and sportsmen (hereinafter sportsmen) in many regions of the world. After a game animal such as, for example, North American big and small game animals, African plains game, a bear, a deer, a goat, a ram, a llama, an ostrich, a seal, an elk, a white- or black-tail deer, a mule, a wild hog, a lion, an elephant, a moose, a bison, and other such animals (regardless of region or continent). is felled or “bagged,” it is common practice to take a “trophy” picture with the felled animal with or without the sportsman who “bagged” the animal and/or members of his hunting entourage. This is often difficult in field conditions, as the felled animal's body and extremities thereof are difficult to position in order to obtain a desirable photograph of the animal. Further, trophy pictures often depict the felled animal with extended body parts such as the animal's head lying on the ground, which is not realistic and does not provide a desirable photograph. Moreover, as large game animals are heavy, it is difficult to properly position the animal's body and extended portions thereof for a trophy photograph. Lastly, this process is even more difficult when hunting alone or when the hunter is disabled and is incapable of (or has great difficulty) positioning a felled animal for a photograph.

Accordingly, there is a need for a portable apparatus which can properly support and/or position a felled animal and/or extended body parts, e.g., head and/or neck, of the animal for capturing a trophy photograph of the animal.

Further, there is a need for an apparatus and/or a method which can accurately and easily position one or more anatomical parts (e.g., extended body parts) of a felled animal so that a desirable photograph of the felled animal may be captured.

### SUMMARY OF THE SYSTEM

Therefore, it is an object of the present system to solve the above-noted and other positioning problems common in the field when hunting game animals and to provide an apparatus and a method for properly positioning one or more parts of a felled animal for capturing a photograph (e.g., still and/or video) of the felled animal.

In one embodiment, a positioning apparatus includes an apparatus for positioning an extremity of an animal including a base part having a cavity and an adjusting mechanism, one or more legs attached to the base part, an extension member structured and arranged so as to fit within the cavity of the base part and engage the adjusting mechanism, an upper part attached to the extension member, the upper part having bifurcated ends and a center section for holding the extremity of the animal in a desired position.

In accordance with another embodiment of the present system, the positioning apparatus may include one or more legs.

In accordance with yet another embodiment of the present system, the positioning apparatus may also include an adjusting mechanism that includes one or more of a friction mechanism, a ratcheting mechanism, and a rack-and-pinion mechanism.

In accordance with still yet another embodiment of the present system, the adjusting mechanism of the positioning apparatus may include a first threaded member which is attached to the base part, a second threaded member having first and second ends and a threaded part which is situated between the first and second ends, the second threaded member structured and arranged to screwably attach to the first threaded member and apply a force to the extension member which is suitable for holding the second member in a desired location relative to the base part, and a handle attached to the second threaded member and suitable for grasping by a user.

In accordance with another embodiment of the present system, the positioning apparatus may further include the bifurcated ends separated from each other so as to form upright members which are hingedly attached to the upper part.

In accordance with yet another embodiment of the present system, the positioning apparatus may include legs that are hingedly located relative to the base part.

In accordance with still yet another embodiment of the present system, the positioning apparatus may further include openings situated in one of the legs and the upright members.

In accordance with another embodiment of the present system, the positioning apparatus may also include upright members that pivot in a single plane.

In accordance with yet another embodiment of the present system, the positioning apparatus including the base part and the upper part may include an adjustment mechanism having two or more gussets each having one or more holes, one or more stop members extending between the gussets and positioned at an end of a corresponding gusset, one or more pins extending through at least one of the holes in the gussets and a corresponding opening of the openings situated in one of the legs and the upright members.

Further, in a method for positioning a felled animal for a trophy photograph (e.g., still and/or video), the method may include the acts of placing the positioning apparatus in a desired position under the extremity of the animal, positioning the extremity of the animal between bifurcated ends of an upper part of the positioning apparatus such that the upper part of the positioning apparatus supports the extremity of the animal from underneath the animal, and raising the extremity of the animal to a desired position using the positioning apparatus.

In accordance with an aspect of the present system, the method may include the act of adjusting the height of the positioning apparatus so that the extremity of the animal is supported at a desired height.

In accordance with another aspect of the present system, the method may include the act of pivoting one or more of a leg and an upright member of the positioning apparatus into a desired position before the placing step.

In accordance with yet another aspect of the present system, the method may include the act of adjusting the height of the position by sliding the upper part relative to a lower part of the support apparatus.

In accordance with still yet another aspect of the present system, the method may include locking the adjusting mechanism in a desired position using a frictional force applied to an extension member of the upper part.

Further, the apparatus according to the present system may also be used to position an extremity (e.g., an animals head, etc.) relative to the animal's body such that, for example, the animal's head may be inline with the body or may be situated at desired angle relative to the body. Moreover, apparatus according to the present system may also be used to adjust the height of an animal's extremity or parts thereof.

Various other features, aspects, and advantages of the present system will become more apparent with reference to the following description and appended claims.

### BRIEF DESCRIPTION OF THE DRAWINGS

Embodiments of the present system will now be described, by way of example, with reference to the accompanying drawings, wherein:

FIG. 1A is a front view illustration of a positioning apparatus according to the present system;

FIG. 1B is a side view illustration of the positioning apparatus shown in FIG. 1A;

FIG. 1C is a cross sectional view illustration of the positioning apparatus taken along lines 1C of FIG. 1A;

FIG. 1D is a cross section view illustration of the positioning apparatus shown in FIG. 1C using a material having a square cross-section;

FIG. 1E is a detailed cross sectional view illustration of the positioning apparatus shown in FIG. 1C;

FIG. 1F is a detailed cross sectional view illustration of the positioning apparatus shown in FIG. 1E with the extension part 104 removed;

FIG. 1G is a detailed cross sectional view illustration of the positioning apparatus shown in FIG. 1D;

FIG. 2A is an exploded front view illustration of a positioning apparatus with an extended adjusting mechanism;

FIG. 2B is an exploded side view illustration of the positioning apparatus shown in FIG. 2A;

FIG. 2C is an exploded front view illustration of a positioning apparatus with a pin type adjusting mechanism;

FIG. 3A is an exploded front view illustration of a positioning apparatus with an alternative locking mechanism;

FIG. 3B is a cross section view illustration of the positioning apparatus taken along lines 3B of FIG. 3A;

FIG. 4A is an exploded front view illustration of a positioning apparatus with a third leg;

FIG. 4B is an exploded side view illustration of the positioning apparatus shown in FIG. 4A;

FIG. 5A is an exploded front view illustration of a positioning apparatus with folding legs and upright members;

FIG. 5B is an exploded side view illustration of the positioning apparatus shown in FIG. 5A;

FIG. 5C is an exploded front view illustration of the positioning apparatus shown in FIGS. 5A and 5B in a folded position; and

FIG. 6 is a side view illustration of the positioning apparatus supporting a fallen trophy animal.

### DETAILED DESCRIPTION OF THE SYSTEM

In the drawings the same reference numerals have been used to indicate corresponding features.

Preferred embodiments of the present system will now be described in detail with reference to the drawings. For the sake of clarity, certain features of the system will not be discussed when they would be apparent to those with skill in the art.

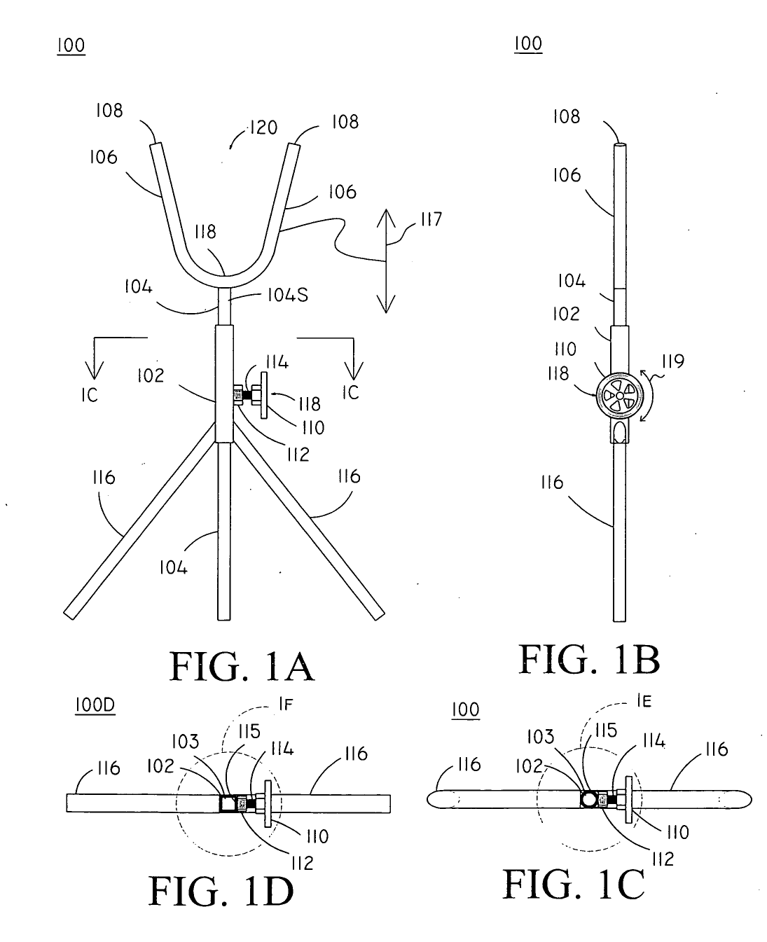

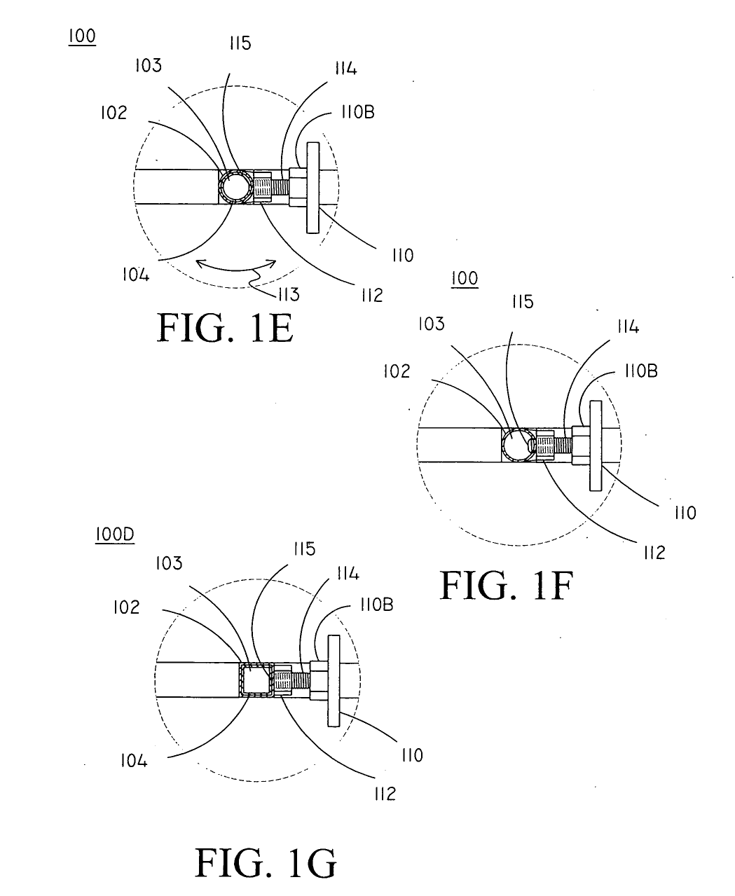

A front view illustration of a positioning apparatus according to the present system is shown in FIG. 1A. The mount apparatus 100 includes one or more of a base part 102, one or more legs 116, an extension part 104, and an adjustment mechanism 118. The base part 102 has an inner cavity 103 for slideably receiving the extension part 104. The adjustment mechanism 118 may include any suitable mechanism which can position the extension part 104 relative to the base part 102. For example, the adjustment mechanism can include a friction member which applies a force against the extension part 104 to lock the extension part 104 in a desired position relative to the base part 102.

The body retaining member 120 is attached to (or formed integrally with) the extension part 104 and is shaped and sized so as to be able to hold a desired body part of an animal (e.g., an extension such as a neck, head, leg, etc.) in a desired location. Accordingly, the body retaining member 120 can include one or more upright members 106 which can terminate at ends 108. The one or more upright members can form all or part of any suitable shape (or parts thereof) suitable for holding an extremity of an animal. For example, suitable shapes can include a “V,” “C,” “U”, “Y”, or other shapes. Further, the upright members can be separated from each other (e.g., at a given point) by a predetermined distance and have a length and/or define an angle which can be predetermined (and or adjusted) so as to be suitable for holding an extremity of a desired game type or animal (e.g., lion). Although not shown, the body retaining member 120 can include one or more fixed and/or adjustable upright members.

The height of the positioning apparatus according to the present system is adjusted by sliding the extension part 104 relative to the base part 102. Accordingly, the height (and/or angle, depending upon embodiment) of the body retaining member 120 can be adjusted as indicated by arrow 117.

The adjustment mechanism 118 can use any suitable mechanism to adjustably lock the extension part 104 in a desired position relative to the base member. Suitable mechanisms can include, for example, a friction fit, a key (e.g., a pin (such as a clevis pin a threaded rod, bolt, etc.) and hole (either threaded or unthreaded) arrangement), a gear (e.g., a rack and pinion), etc., as desired. Accordingly, the adjustment mechanism 118 can include a threaded member 114, a turning mechanism such as, for example, a handle 110 (or other mechanism to turn the threaded member 114 such as a bolt head a screw head, etc.) and a threaded area structured and arranged to receive the threaded member 114. The threaded area can include a nut which is attached to the base part 102 using any suitable method (e.g., welding, pressure fitting, bonding, a threaded fitting, etc.). However, it is also envisioned that the threaded area may be formed integrally with the base part 102 by threading a wall of the base part 102 such that the threads are structured and arranged to screwably receive the threaded member 114. In operation, the threaded member 114 can be rotated (e.g., using the handle 110, a drive mechanism—not shown, etc.) so as to adjust a force which it can apply against a side wall 104S of the extension part 104. When a sufficient force is applied against the side wall 104S of the extension part 104, the extension part 104 will be “locked” in position relative to the base part 102. Likewise, by rotating the threaded member 114 in an opposite direction, the threaded member 114 will move in an opposite direction and, thus, reduce (or eliminate) the force which is applied against the wall 104S of the extension part 104. Accordingly, the extension part 104 can then be slideably positioned (and/or adjusted) relative to the base part 102. However, it is also envisioned that the threaded member may fit into one or more holes or detents which can be part of the extension part. Although not shown, the force applied to the extension part 104 by the threaded member may be applied via a shoe (e.g., a friction shoe) and/or other elements (e.g., a cam mechanism) so as to provide a desired frictional force if necessary. Moreover, although not shown, a linkage arrangement may also be used to transfer a force suitable for locking the extension part in a desired position. Further, it is also envisioned that the threaded member can include a set screw. Moreover, the end of the set screw may include any suitable type end for locking the extension part in a desired position with minimal force. Accordingly, the set screw can include a flat point, a domed point, a cone point, a knurled cup point, a dog point, or combinations thereof, as desired. Further, the legs according to the present system may include a taper such that they may be driven into the ground more easily and/or may include a flat surface having an area which may provide additional support (e.g., in sandy areas). The flat surface may be fixed, removable and/or adjustable, such that it may be positioned at the end of one or more of the legs or may be positioned a predetermined distance from one or more ends of a corresponding leg. Accordingly, the leg may be driven into the ground by a desired amount and then supported, in part, by the flat surface. Further, although the handle depicted as part of the adjustment mechanism 118 is circle in shape, it is to be understood that the handle maybe any shape, e.g., triangular, square, elliptical, etc., or any other desirable shape, e.g., a cylindrical bar (solid or hollow), flat stock (such as flat steel), conventional window crank, etc.

A side view illustration of the positioning apparatus of FIG. 1A is shown in FIG. 1B. The handle 110 can be rotated in the direction of arrow 119 so as to lock and/or unlock (e.g., by adjusting friction) the extension part 104.

A cross section view illustration of the positioning apparatus taken along lines 1C of FIG. 1A is shown in FIG. 1C. As shown, the positioning apparatus 100 (or parts thereof) can be formed from tubular (e.g., tube, pipe, etc.) and/or solid materials which can include, for example, aluminum, steel, fiberglass, carbon fiber, PVC (polyvinyl chloride), etc. However, it is also envisioned that other metals, polymers (e.g., wood, cardboard, etc.), and/or combinations thereof may be used. The extension apparatus 104 is seen in FIGS. 1E and 1G which are described below.

A cross section view illustration of the positioning apparatus shown in FIG. 1C using a material having a square cross-section is shown in FIG. 1D. Positioning apparatus 100D is similar to the positioning apparatus 100, with a difference being that the positioning apparatus 100D is formed in whole (or in part) using any suitable material that has a square cross section in whole or in part. For example, a suitable material may include a material having a shape such as square tubing or piping, square rod, etc.

A detailed cross sectional view illustration of the positioning apparatus shown in FIG. 1C is shown in FIG. 1E. The threaded rod 114 may include a gripping portion 110B which is structured and arranged to receive an optional force from, for example, a wrench, etc. Likewise, the optional handle 110 is structured and arranged to receive a force from, for example, a user's hand, and can have a suitable diameter and material such that a user is not inconvenienced when using the handle 110 to tighten/loosen the adjusting mechanism 118. The threaded rod 114 has an end 115 which can be structured and arranged to provide a proper frictional force against the side wall 104S of the extension part 104. An advantage of using the tubular base part 102 is that the extension part 104 may be optionally rotated (e.g., in the direction of arrow 113) relative to the tubular part 102 if desired. However, a rotation-preventing mechanism (e.g., a keyway/channel configuration) may be included to prevent rotation of the extension part relative to the base part when using tubular construction. For example, the one of base part or extension part may include a keyway and the other of the base part or extension part may include a key which is structured and arranged to fit within the keyway. Moreover, the key may be formed as part of the threaded rod (e.g., an end of a set screw) or shoe of the adjustment mechanism.

A detailed cross sectional view illustration of the positioning apparatus shown in FIG. 1E with the extension part removed is shown in FIG. 1F. The extension part 104 (not shown) fits into the inner cavity 103 of the base part 104. The end 115 of the threaded member 114 may include a gripping surface to increase a frictional force against the extension part 104. However, it is also envisioned that the extension part 104 may include protrusions, detents, holes, cuts, etc. to receive a part of the threaded member 114 or other suitable adjustment mechanism member. For example, suitable adjustment mechanism members can include one or more of a pin (e.g., a clevis pin), a rod, a screw (e.g., a set screw), a friction element, a cam operated friction element, a clamp, etc.

A detailed cross sectional view illustration of the positioning apparatus shown in FIG. 1D is shown in FIG. 1G. As shown, one or more parts of the positioning apparatus 100D may be formed using, for example, a material having a square cross section. Further, by using a square cross section, rotation of the extension part 104 when mounted within the base part 102 can be minimized or prevented, if desired.

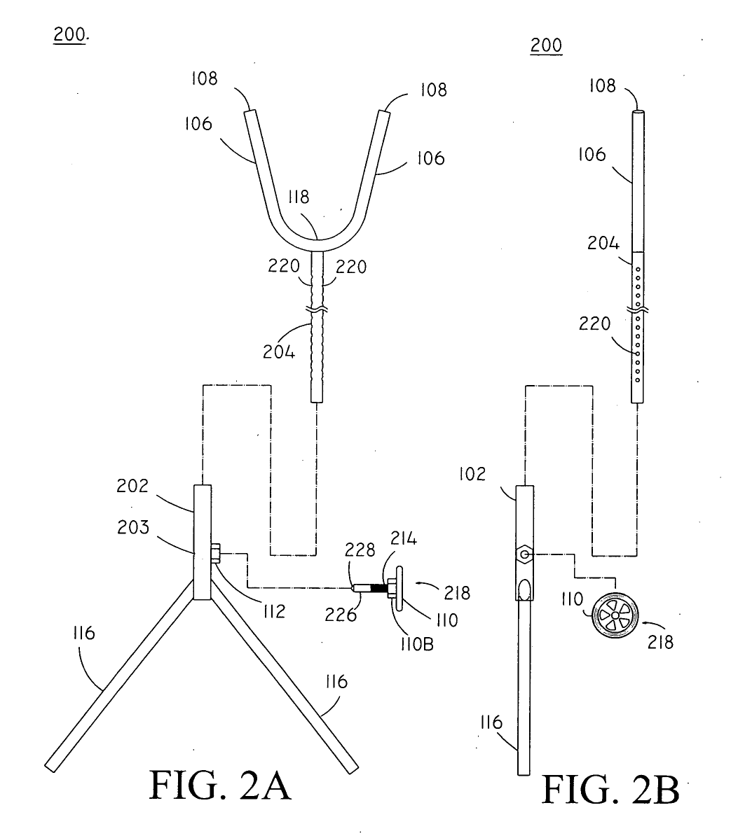

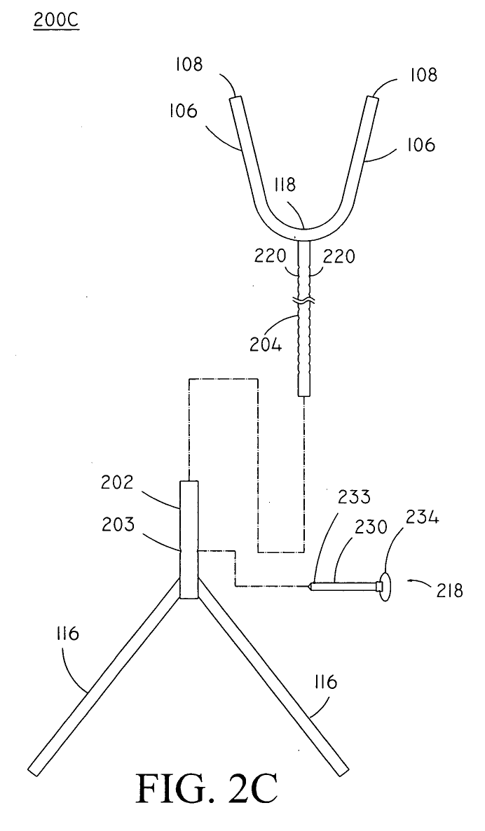

An exploded front view illustration of another positioning apparatus with an extended adjusting mechanism is shown in FIG. 2A. Positioning apparatus 200 is similar to the positioning apparatus shown in FIGS. 1A-1G with a difference being that the extension part 204 (which is similar to the extension part 104) includes one or more holes 220 for receiving at least part of an adjusting mechanism 218. Accordingly, rather than using an optional friction force to position the extension part as shown in FIG. 1, an extended part 226 (with end 228) can be inserted within the holes 220 to position the extension part 204 relative to a base part 202. Further, the base part may include a hole 205 for receiving at least part of the adjusting mechanism 218 when the adjusting mechanism is in a locked position. Moreover, the adjusting mechanism 218 can include a threaded member 112 that is structured and arranged to screwably receive at least part of an optional threaded area 214 of the adjusting mechanism 218. Accordingly, the adjusting mechanism can be locked in place. However, in alternative embodiments, it is envisioned that the adjusting mechanism can include a pin (or rod, etc.) with an optional detent (for locking it in a desired position) which can be placed, at least in part, within corresponding holes in the base part and the extension part 204 so as to lock the extension part in place.

An exploded side view illustration of the positioning apparatus shown in FIG. 2A is seen in FIG. 2B. As shown, the extension part 220 includes one or more holes 204. The holes 220 can be located opposite each other as shown. However, it is also envisioned that the holes 220 can be placed such that the end 228 of the adjusting mechanism 118 cannot pass entirely through the extension part 208. Moreover, the holes can be replaced by indents, notches, or other suitable elements which can receive at least part of the adjusting mechanism 118 (e.g., the threaded rod of the adjusting mechanism) so as to lock the adjustment part 104 in a desired position.

An exploded front view illustration of a positioning apparatus with a pin type adjusting mechanism is shown in FIG. 2C. Positioning apparatus 200C is similar to the positioning apparatus shown in FIGS. 2A-2B with a difference being that the adjusting mechanism includes an optional pin 230 to lock the extension part 204 in place relative to the base part 202. Accordingly, the threaded member 112 may not be necessary. A locking means such as, for example, a cord or a ball bearing 233 (as is known in the art) may be used to lock the pin in a desired position. Further, the pin 230 may include a gripping member such as, for example, a tab, a pull ring 234, etc. so that a user may easily insert and/or remove the pin 230 when using the positioning apparatus 200C.

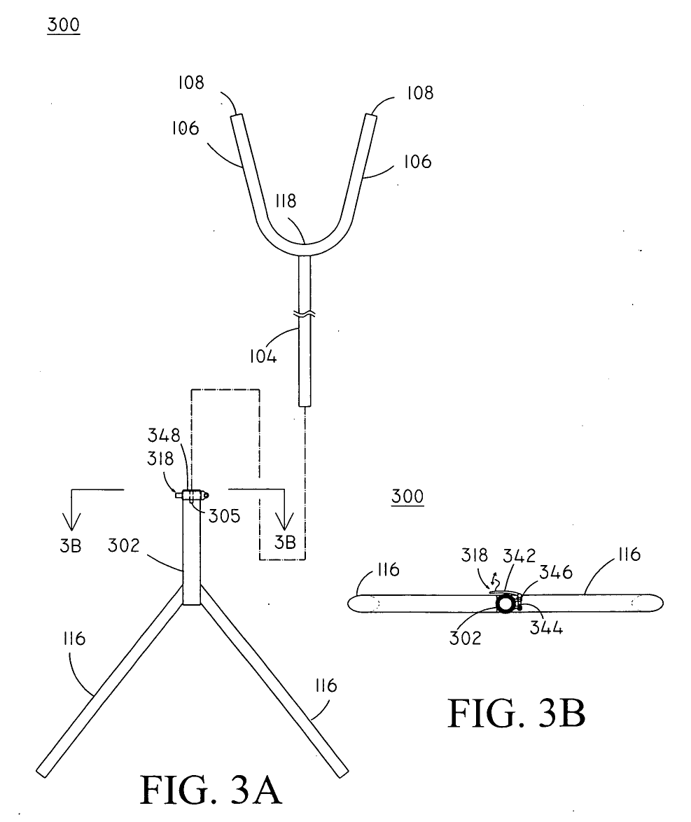

An exploded front view illustration of a positioning apparatus with an alternative locking mechanism is shown in FIG. 3A. The positioning apparatus is similar to the positioning apparatus shown FIG. 1A; however, the adjusting mechanism includes a clamping mechanism 318 to clamp the extension part 104 in a desired position relative to a base part 302. The clamping mechanism 318 is positioned adjacent to an end part 348 of the base part 302 and can provide a clamping force to the adjusting part 104 by itself or via the base part 302 as shown. Accordingly, the base part may include a cutaway portion 305 so that the base part 302 can deflect in response to a force from the clamping mechanism 318 that is situated around at least part of the base part 302. The clamping mechanism 318 can include any suitable adjustable clamp, such as, for example, a clamp which is similar to a (bicycle) seat post collar and can include a quick release device such as a binder bolt with a quick release which are commonly used to position bicycle seat posts.

A cross section view illustration of the positioning apparatus taken along lines 3B of FIG. 3A is shown in FIG. 3B. The clamping mechanism 318 can include a quick release lever 342 which rotates a cam 346 that applies or releases a tension which is applied to a bolt 344 to tighten or loosen the clamping mechanism 318. It is also envisioned that rather than place the clamping mechanism 318 around the base part 302, the clamping mechanism can be attached to an end of the base part and make direct contact with the extension part 104. As such clamps are known in the art, a further description thereof will not be provided.

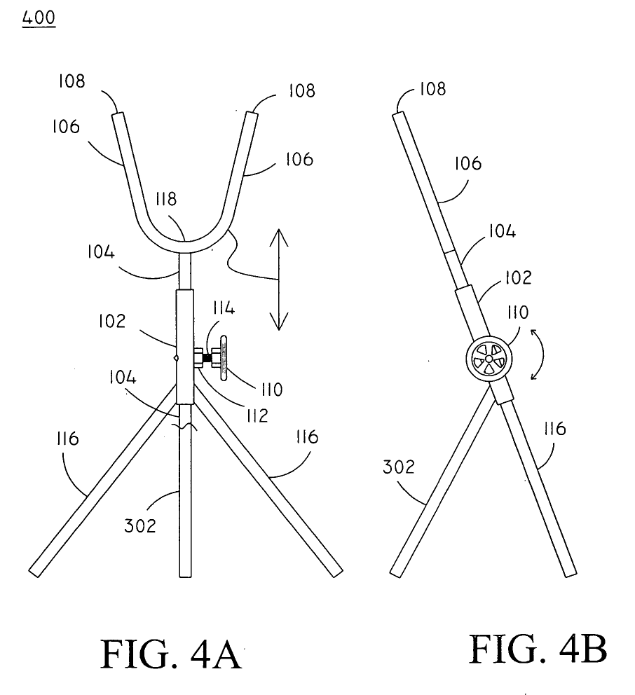

An exploded front view illustration of a positioning apparatus with a third leg is shown in FIG. 4A. Positioning apparatus 400 is similar to the positioning apparatus shown in FIG. 1, with a difference being the addition of one or more optional legs 402. The size and/or angle of leg 402 relative to the body part 102 can be adjusted so as to position the base part 102 in a desired position when legs 116 and 402 contact the ground. It is also envisioned that one or more of legs 116 and/or 402 can be hingedly attached relative to the base part 102 so as to be adjustable. Accordingly, a locking apparatus (not shown) can be used to locate the legs in a desired position, as desired.

An exploded side view illustration of the positioning apparatus shown in FIG. 4A is shown in FIG. 4B. The leg 402 can be attached to the base part 102 using any suitable method (e.g., hinges, bolts, flanges, welds, etc.) as desired.

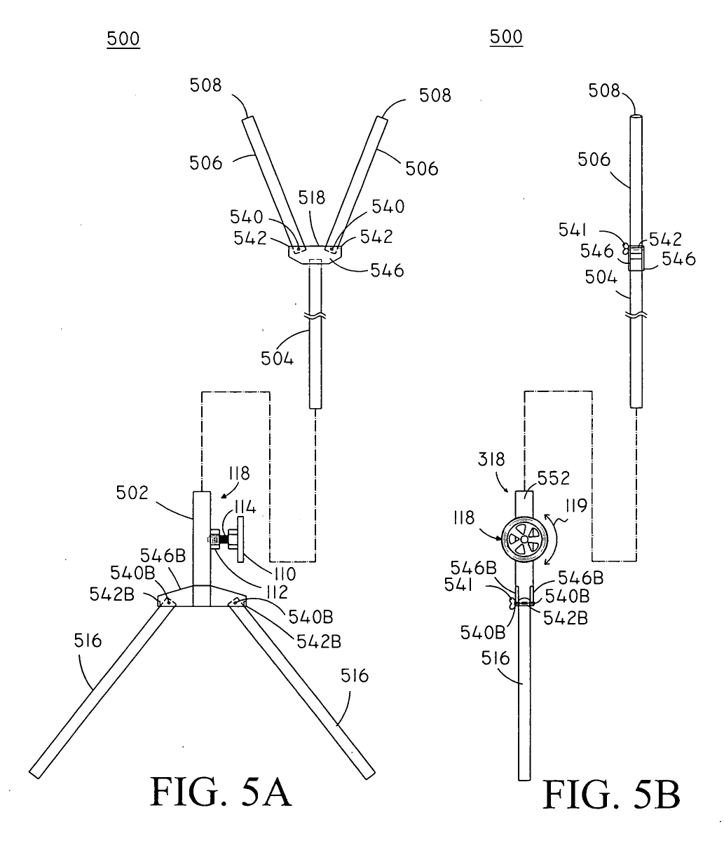

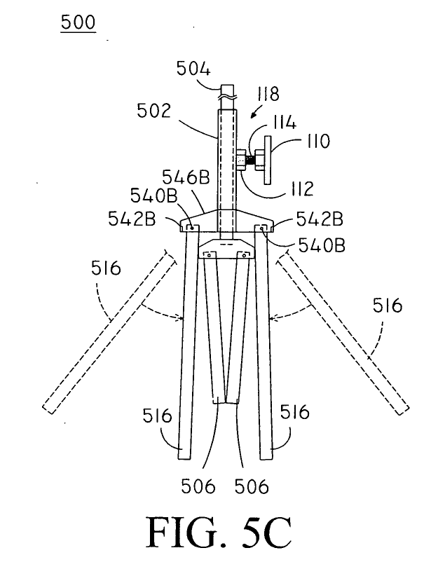

An exploded front view illustration of a positioning apparatus with folding legs and upright members is shown in FIG. 5A. Positioning apparatus 500 is similar to the positioning apparatus shown in FIG. 1A with a difference being the use of folding legs 516 and optional folding upright members 506. Although an adjusting mechanism 118 is similar to the adjusting mechanism shown in FIG. 1A, any suitable adjusting mechanism may be used. For example, suitable adjusting mechanisms may include a friction adjusting mechanism (such as a cam-type mechanism), a pin-type (e.g., a clevis pin, a threaded rod, a screw, etc.) adjusting mechanism, a ratcheting-type adjusting mechanism, etc.

The positioning apparatus 500 includes a base part 502, an extension part 504, and an adjustment mechanism 518.

The base part 502 is similar to the base part 102 shown in FIG. 1A, however, it includes gussets 546B which are attached to the base part 502 so as to form a space in which legs 516 may be pivotally attached using any suitable method. For example, legs 516 may be attached to one or more of the flanges using an attachment element such as one or more pins, bolts, rivets, rods, etc. Accordingly, each of the gussets 546B can include a hole through which a part of the attachment element passes. Likewise, each of the legs 516 can include a hole through which the attachment element passes. As shown in FIG. 5A, the legs 516 can be attached to the gussets 546B using any suitable method. For example, the legs 516 can be attached to the gussets 546B using one or more attachment element such as hinges, pins, bolts, rods, rivets, hinges, linkages etc. As shown in FIG. 5A a threaded rod 540B is inserted through corresponding holes in the gussets 540B and the legs 516. Although not shown, one or more nuts (e.g., wing nuts 541B) can be threaded on each side of the threaded rod 540B to apply a force against the gussets 546B and a leg 516 so that the corresponding leg 516 does not freely pivot when the one or more nuts 540 are tightened. Accordingly, the legs 516 may be locked in an open and/or in a closed position. However, if the threaded rod includes a bolt, only a single nut 540 (or other fastening device such as a quick connect/disconnect fastener) may be used. Further, one side of the threaded bolt 540B may be locked in place such that it does not rotate relative to the gussets 546B when tightened using any suitable method (e.g., welding, a lock nut, etc.). Optional stop members 542B can be attached (e.g., using any suitable method such as, for example, welding, bonding, etc.) to the gussets 546B and are placed so as to limit an angular displacement of the legs 516 about one or more pivot points such as a pivot point defined by an axis of the threaded bolt 540B. The base part 502 may include any suitable adjusting mechanism for holding the extension part 504 in a desired position. For example, an adjusting mechanism 118 can be used.

The extension part 504, similarly to the base part 502, may include adjustable gussets 546 which are situated and arranged so as to form an area for receiving upright members 506. The upright members 506 can be adjustably (e.g., pivotably, rotatably, hingedly, etc.) attached to the gussets 546 using any suitable method. For example, the upright members 506 can be attached to the gussets using one or more attachment element such as hinges, pins, bolts, rods, screws, rivets, hinges, linkages, etc. Accordingly, each of the gussets can include a hole through which a part of the attachment element passes. Likewise each of the upright members 506 can include a hole through which the attachment element passes. As shown in FIG. 5A, the upright members 506 can be attached to the gussets 546 using a threaded rod (or bolt) 540. One or more nuts (e.g., wing nuts 541, or quick release mechanism (e.g., a cam-operated fastener) can be threaded on one or more sides of the threaded rods 540 so as to apply a force against the gussets 546 and a corresponding upright 506 so that the corresponding upright member 506 does not freely pivot when the one or more nuts 541 are tightened. Accordingly, the upright members 506 may be locked in an open and/or in a closed position. Further, one side of the threaded rod 540 may be locked in place such that it does not rotate relative to the gussets 546 when tightened using any suitable method (e.g., welding, a lock nut, etc.). Optional stop members 542 can be attached (e.g., using any suitable method such as, for example, welding, bonding, etc.) to the gussets 546 and are placed so as to limit an angular displacement of the upright members 506 about the threaded rod 540.

An exploded side view illustration of the positioning apparatus shown in FIG. 5A is shown in FIG. 5B. The positioning apparatus 500 may include winged nuts 541 and 541B as shown attached to one or more sides of the attachment elements 540 and 540B. If desired, these winged nuts can be tightened to “snug” the gussets 546 and 546B respectively against the upright members 506 and/or the legs 516 so that they do not freely pivot. However, it is also envisioned that a cam mechanism (or other mechanism) can optionally be used to snug the gussets 546 and 546B respectively against the upright members 506 and/or the legs 516 so that they do not freely pivot. The extension part 504 is shaped and sized so that it can be slideably inserted within a cavity of the base part 502.

An exploded front view illustration of the positioning apparatus shown in FIGS. 5A and 5B in a folded position is shown in FIG. 5C. The extension part 504 of the positioning apparatus 500 can be slideably removed from the channel of base part 502 and reinserted so as to minimize the space needed to carry the positioning apparatus 500 when it is not being used (e.g., when placed in a hunter's gear pack).

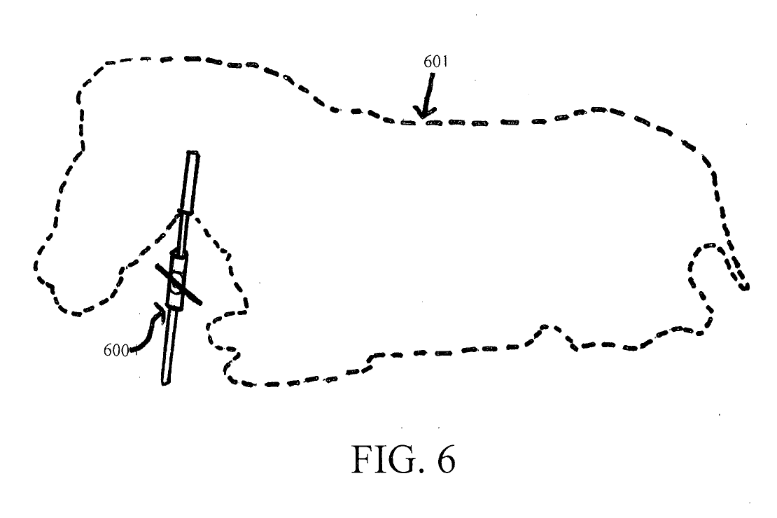

FIG. 6 is a side view illustration of the positioning apparatus supporting a fallen trophy animal. In FIG. 6, the mount apparatus 600 is shown positioning an extremity of an animal 601. Further, the mount apparatus may include a color such that it blends in with a captured photograph. For example, the mount apparatus may include a color scheme such that it blends in with an expected background. Further, the mount apparatus may include camouflage (e.g., a plant-like object such as, grass, etc.) and/or a mechanism to mount the camouflage such that it may easily blend in with a captured image.

Thus, according to the present system, a low-cost, stable, and easy-to-use positioning apparatus that can be easily operated and used is provided.

Certain additional advantages and features of this system may be apparent to those skilled in the art upon studying the disclosure, or may be experienced by persons employing the novel system and method of the present system, chief of which is that a more stable and easy-to-use trophy-photo positioning apparatus which can be easily carried and operated is provided. Another advantage of the present system is that conventional tripod bases can be easily modified to incorporate the features and advantages of the present system.

Further, although various embodiments of the present system are shown in the drawings and/or described in the corresponding text, with the proper discretion, one or more elements of one or more embodiments may be combined with and/or replaced by one or more elements of a different embodiment. For example, the base part having fixed legs of FIG. 1A can be used with the extension part 504 of FIG. 5A with minimal change in function.

While the system has been described with a limited number of embodiments, it will be appreciated that changes may be made without departing from the scope of the original claimed system, and it is intended that all matter contained in the foregoing specification and drawings be taken as illustrative and not in an exclusive sense.

What is claimed is:

1. An apparatus for positioning an extremity of an animal, comprising:
a base part having a cavity and an adjusting mechanism;
one or more legs attached to the base part;
an extension member structured and arranged so as to fit within the cavity of the base part and engage the adjusting mechanism;
an upper part attached to the extension member, the upper part having bifurcated ends and a center section for holding the extremity of the animal in a desired position.

2. The apparatus of claim 1, wherein the apparatus has only two legs.

3. The apparatus of claim 2, wherein the adjusting mechanism comprises one or more of a friction mechanism, a ratcheting mechanism, and a rack-and-pinion mechanism.

4. The apparatus of claim 3, wherein the adjusting mechanism comprises:
a first threaded member which is attached to the base part;
a second threaded member having first and second ends and a threaded part which is situated between the first and second ends, the second threaded member structured and arranged to screwably attach to the first threaded member and apply a force to the extension member which is suitable for holding the second member in a desired location relative to the base part; and
a handle attached to the second threaded member and suitable for grasping by a user.

5. The apparatus according to claim 1, wherein the bifurcated ends are separate from each other so as to form upright members which are hingedly attached to the upper part.

6. The apparatus according to claim 5, wherein the legs are hingedly located relative to the base part.

7. The apparatus according to claim 6, further comprising openings situated in one of the legs and the upright members.

8. The apparatus of claim 7 wherein the upright members pivot in a single plane.

9. The apparatus of claim 7, wherein the base part and the upper part comprise an adjustment mechanism comprising:
two or more gussets each having one or more holes;
one or more stop members extending between the gussets and positioned at an end of a corresponding gusset;
one or more pins extending through at least one of the holes in the gussets and a corresponding opening of the openings situated in one of the legs and the upright members.

10. A method for positioning an extremity of an animal using a positioning apparatus, the method comprising the acts of:
placing the positioning apparatus in a desired position under the extremity of the animal;
positioning the extremity of the animal between bifurcated ends of an upper part of the positioning apparatus such that the upper part of the positioning apparatus supports the extremity of the animal from underneath the animal; and
raising the extremity of the animal to a desired position using the positioning apparatus.

11. The method of claim 10, further comprising the act of adjusting the height of the positioning apparatus so that the extremity of the animal is supported at a desired height.

12. The method of claim 11, further comprising the act of pivoting one or more of a leg and an upright member of the positioning apparatus into a desired position before the placing step.

13. The method of claim 11, wherein the adjusting is performed by sliding the upper part relative to a lower part of the support apparatus.

14. The method of claim 13, further comprising locking the adjusting mechanism in a desired position using a frictional force applied to an extension member of the upper part.
